(19) United States
(12) Patent Application Publication
(10) Pub. No.: US 2018/0188906 A1
(43) Pub. Date: Jul. 5, 2018

(54) DYNAMICALLY GENERATING A SUBSET OF ACTIONS

(71) Applicant: Google Inc., Mountain View, CA (US)

(72) Inventor: Bernadette Alexia Carter, Santa Clara, CA (US)

(21) Appl. No.: 15/398,502

(22) Filed: Jan. 4, 2017

(51) Int. Cl. G06F 3/0482; G06F 3/0481

(52) U.S. Cl. CPC G06F 3/0482; G06F 3/04883; G06F 3/04817

(57) ABSTRACT

A method includes outputting a graphical user interface that includes a single graphical element corresponding to grouping of a plurality of applications. A plurality of actions is associated with the plurality of applications, each action from the plurality of actions is an action to be performed by the respective application during executing the respective application. The method includes determining, from the plurality of actions, a subset of actions that are more likely to be selected, by a user, than other actions from the plurality of actions that are not included in the subset. The method also includes receiving an indication of a user input that selects the single graphical element and determining whether the user input is a first type of input or a second type of input. The method further includes, if the user input is a second type of user input, outputting, a graphical indication of the subset of actions.

### BACKGROUND

Some computing devices (e.g., mobile phones, tablet computers, computerized watches, etc.) may have multiple software applications installed. The computing device may provide a graphical user interface (GUI) that enables a user to select a respective graphical element (e.g., an icon) to execute one of the multiple applications. To avoid clutter or aid in organization of a GUI, a computing device may enable grouping of multiple such graphical elements into a single graphical element (e.g., a folder) that hides or minimizes the respective graphical elements of the individual applications in the group, until the single graphical element associated with the group is selected via an initial user input.

After receiving an initial user input that selects a group and displaying the respective graphical elements of individual applications in the group, the computing device may require additional user input to select a particular application for execution. The computing device may then require even more user inputs before causing the selected application to perform a particular function or action. Thus, some computing devices may require numerous user inputs before executing a single application to perform a single function or action, particularly when the respective graphical element of the application that has been grouped with graphical elements of other applications into a single graphical element associated with the group.

### SUMMARY

The disclosed subject matter relates to particular techniques for dynamically generating and displaying actions. A computing device may provide a graphical user interface providing a graphical element, such as an icon, that is associated with a group or grouping of software applications. For example, the graphical element may represent a folder containing or providing access to the applications in some way. The computing device may be arranged to determine a subset of one or more actions, that are associated with the group of applications, that a user is most likely to want the computing device to execute after selecting the graphical element that is associated with the group of applications. In response to determining the subset of actions, the computing device may display, within the GUI, selectable graphical indications of each action from the subset of actions in response to detecting a first user input that selects the graphical element associated with the group. The computing device may execute a particular action from the subset of actions in response to receiving a second input that selects a corresponding selectable graphical indication that is being displayed.

By predicting and displaying selectable graphical indications of a subset of the actions that a user is more likely to cause the computing device to execute after selecting a graphical element that is associated with the group of applications, the computing device may require fewer user inputs to cause the computing device to perform a particular action associated with a particular application in the group, which may cause a more convenient or pleasing user experience, enable quicker operations, increase the performance of the computing device, and decrease the amount of power consumed by the computing device as compared to other computing devices that require more user inputs to perform actions.

In one example, the disclosure describes a method that includes outputting, by a computing device and for display at a display device, a graphical user interface that includes a single graphical element corresponding to a grouping of a plurality of applications. A plurality of actions is associated with the plurality of applications, each action from the plurality of actions is associated with a respective application from the plurality of applications, and each action from the plurality of actions is an action to performed by the respective application during execution of the respective application. The method includes determining, by the computing device, from the plurality of actions, a subset of actions that are more likely to be selected, by a user, than other actions from the plurality of actions that are not included in the subset. The method also includes receiving, by the computing device, an indication of a user input that selects the single graphical element. The method further includes determining, by the computing device, whether the user input is a first type of user input or a second type of user input. The method also includes, if the user input is a first type of user input, outputting, by the computing device and for display at the display device, a plurality of graphical elements, wherein each graphical element of the plurality of graphical elements corresponds to a respective application from the plurality of applications. The method also includes if the user input is a second type of user input, outputting, by the computing device and for display at the display device, a graphical indication of the subset of actions.

In another example, the disclosure describes a computing device comprising: at least one processor and a memory. The memory comprises instructions that, when executed by the at least one processor, cause the at least one processor to output, for display at a display device, a graphical user interface that includes a single graphical element corresponding to a grouping of a plurality of applications. A plurality of actions is associated with the plurality of applications, each action from the plurality of actions is associated with a respective application from the plurality of applications, and each action from the plurality of actions is an action to be performed by the respective application during execution of the respective application. The instructions cause the at least one processor to determine, from the plurality of actions, a subset of actions that are more likely to be selected, by a user, than other actions from the plurality of actions that are not included in the subset. The instructions also cause the at least one processor to receive an indication of a user input that selects the single graphical element and determine whether the user input is a first type of user input or a second type of user input. The instructions further cause the at least one processor to, if the user input is a first type of user input, output, for display at the display device, a plurality of graphical elements, wherein each graphical element of the plurality of graphical elements corresponds to a respective application from the plurality of applications. The instructions additionally cause the at least one processor to, if the user input is a second type of user input, output, for display at the display device, a graphical indication of the subset of actions.

In another example, the disclosure describes a computer-readable storage medium encoded with instructions that, when executed by at least one processor of a computing device, cause the at least one processor to output, for display at a display device, a graphical user interface that includes a single graphical element corresponding to a grouping of a plurality of applications. A plurality of actions is associated with the plurality of applications, each action from the plurality of actions is associated with a respective application from the plurality of applications, and each action from the plurality of actions is an action to be performed by the respective application during execution of the respective application. The instructions cause the at least one processor to determine, from the plurality of actions, a subset of actions that are more likely to be selected, by a user, than other actions from the plurality of actions that are not included in the subset. The instructions also cause the at least one processor to receive an indication of a user input that selects the single graphical element and determine whether the user input is a first type of user input or a second type of user input. The instructions further cause the at least one processor to, if the user input is a first type of user input, output, for display at the display device, a plurality of graphical elements, wherein each graphical element of the plurality of graphical elements corresponds to a respective application from the plurality of applications. The instructions additionally cause the at least one processor to, if the user input is a second type of user input, output, for display at the display device, a graphical indication of the subset of actions.

In one example, the disclosure describes a system that includes means for outputting, for display at a display device, a first graphical user interface that includes a single graphical element corresponding to a grouping of a plurality of applications. A plurality of actions is associated with the plurality of applications, each action from the plurality of actions is associated with a respective application from the plurality of applications, and each action from the plurality of actions is an action to be performed by the respective application during execution of the respective application. The system includes means for determining, from the plurality of actions, a subset of actions that are more likely to be selected, by a user, than other actions from the plurality of actions that are not included in the subset. The system also includes means for receiving an indication of a user input that selects the single graphical element and means for determining whether the user input is a first type of user input or a second type of user input. The system also includes, if the user input is a first type of user input, means for outputting, for display at the display device, a plurality of graphical elements, wherein each graphical element of the plurality of graphical elements corresponds to a respective application from the plurality of applications. The system additionally includes, if the user input is a second type of user input, means for outputting, for display at the display device, a graphical indication of the subset of actions.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system that dynamically generates and displays groups of actions, in accordance with one or more aspects of the present disclosure.

FIG. 2 is a block diagram illustrating an example computing device that is configured to dynamically generate and display a subset of actions, in accordance with one or more aspects of the present disclosure.

FIG. 3 is a block diagram illustrating an example computing device that is configured to dynamically generate and display a subset of actions for display at a remote device, in accordance with one or more aspects of the present disclosure.

FIGS. 4A-4B are conceptual diagrams illustrating example graphical user interfaces of an example computing device that is configured to dynamically generate and display a subset of actions, in accordance with one or more aspects of the present disclosure.

FIG. 5 is a flowchart illustrating example operations of a computing device that is configured to dynamically generate and display a subset of actions, in accordance with one or more aspects of the present disclosure.

### DETAILED DESCRIPTION

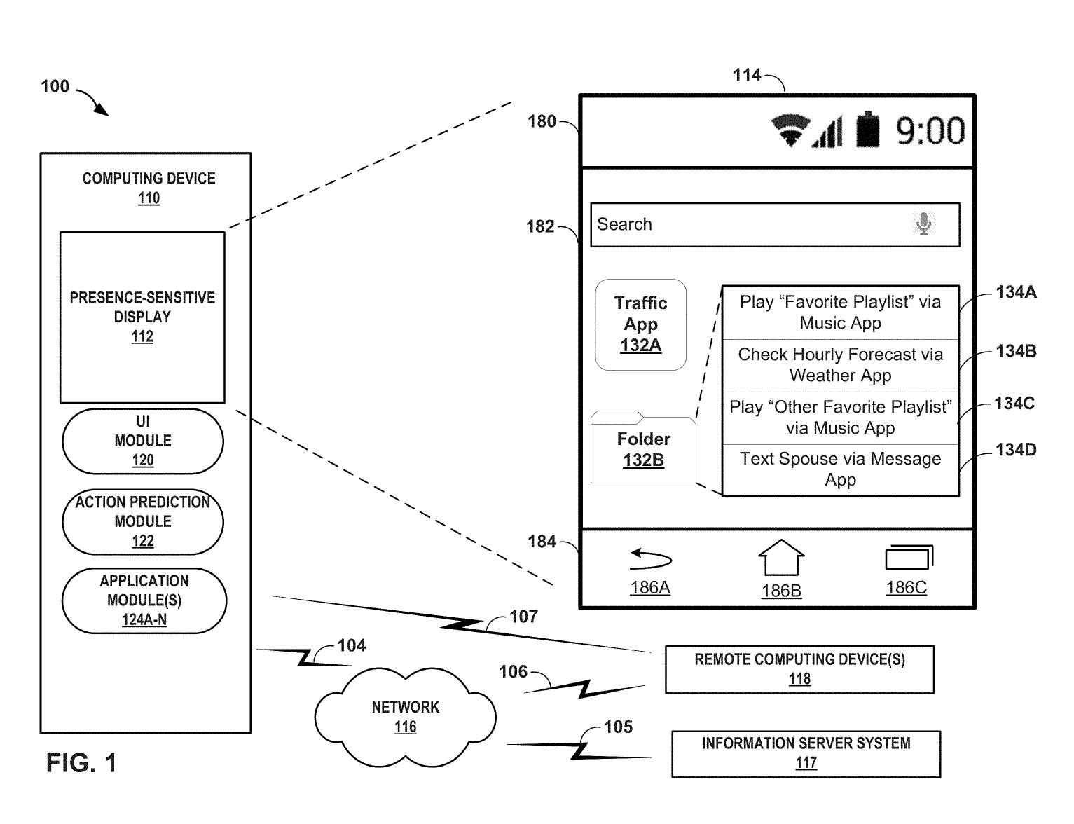

FIG. 1 is a conceptual diagram illustrating an example system that dynamically generates and displays sets of actions, in accordance with one or more aspects of the present disclosure. System 100 may include computing device 110, information server system (ISS) 117, and one or more remote computing device 118 that are communicatively coupled via network 116.

Network 116 represents any public or private communications network, for instance, cellular, Wi-Fi, and/or other types of networks, for transmitting data between computing systems, servers, and computing devices. Network 116 may include one or more network hubs, network switches, network routers, or any other network equipment, that are operatively inter-coupled thereby providing for the exchange of information between computing device 110, ISS 117, and remote computing devices 118. Computing device 110, ISS 117, and remote computing devices 118 may send and receive data via network 116 using any suitable communication techniques. Computing device 110, ISS 117, and remote computing devices 118 may send and receive data via different types of networks 116. For example, ISS 117 may exchange data with computing device 110 via a cellular network and computing device 110 may exchange data with remote computing device 118 via Wi-Fi.

Computing device 110, ISS 117, and remote computing device 118 may each be operatively coupled to network 116 using respective network links 104, 105, and 106. Computing device 110, ISS 117, and remote computing device 118 may be operatively coupled to network 116 using different network links. The links coupling computing device 110, ISS 117, and remote computing device 118 to network 116 may be Ethernet, ATM or other types of network connections, and such connections may be wireless and/or wired connections.

Remote computing devices 118 may be any type of remote computing device, such as a smartphone, a computerized wearable device (e.g., a watch, eyewear, ring, necklace, etc.), speaker, television, automobile head unit, or any other type of that is configured to send and receive information to and from computing device 110 via a network, such as network 116. Remote computing device 118 may execute one or more applications such as media applications (e.g., music, video, or the like), messaging applications (e.g., email, text, or the like), or any other type of application. Remote computing device 118 may exchange information with computing device 110 via network 116. For example, remote computing device 118 may send information to computing device 110 and may receive information from computing device 110. Remote computing device 118 may also exchange information with computing device 110 without traversing network 116, for example, using direct link 107. Direct link 107 may be any communication protocol or mechanism capable of enabling two computing devices to communicate directly (i.e., without requiring a network switch, hub, or other intermediary network device), such as Bluetooth®, Wi-Fi Direct®, near-field communication, etc.

ISS 117 represents any suitable remote computing system, such as one or more desktop computers, laptop computers, mainframes, servers, cloud computing systems, etc. capable of sending and receiving information via a network, such as network 116. ISS 117 may host applications and data for contextual information, music, weather information, traffic information, messaging information (e.g., email, text messages), calendar information, social media, news information, etc. ISS 117 may represent a cloud computing system that provides information to computing device 110 via network 116, such that computing device 110 may output at least a portion of the information provided by ISS 117 to a user.

Computing device 110 may be a mobile device, such as a smart phone, a tablet computer, a laptop computer, computerized watch, computerized eyewear, computerized gloves, or any other type of portable computing device. Additional examples of computing device 110 include other mobile and non-mobile devices, such as desktop computers, televisions, personal digital assistants (PDA), portable and non-portable gaming systems, digital media players or micro-consoles, e-book readers, mobile television platforms, automobile navigation and entertainment systems, vehicle cockpit displays, or any other types of wearable and non-wearable, mobile or non-mobile computing devices.

Computing device 110 includes a presence-sensitive display (PSD) 112, user interface (UI) module 120, action prediction module 122, and one or more application modules 124. Modules 120, 122, and 124 may perform operations described using software, hardware, firmware, or a mixture of hardware, software, and firmware residing in and/or executing at computing device 110. Computing device 110 may execute modules 120, 122, and 124 with multiple processors or multiple devices. Computing device 110 may execute modules 120, 122, and 124 as virtual machines executing on underlying hardware. Modules 120, 122, and 124 may execute as one or more services of an operating system or computing platform. Modules 120, 122, and 124 may execute as one or more executable programs at an application layer of a computing platform.

PSD 112 of computing device 110 may function as respective input and/or output devices for computing device 110. In particular, when operating as an input device, PSD 112 is described below as being configured to detect an amount of force or amount of pressure associated with an input. As used throughout the disclosure, pressure is defined as force per unit area.

PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may receive tactile input from a user of respective computing device 110. PSD 112 may receive indications of tactile input by detecting one or more gestures from a user (e.g., the user touching or pointing to one or more locations of PSD 112 with a finger or a stylus pen). PSD 112 may output information to a user as a user interface (e.g., graphical user interface 114, which may he associated with functionality provided by computing device 110. For example, PSD 112 may display various user interfaces related to an application module or other features of computing platforms, operating systems, applications, and/or services executing at or accessible from computing device 110. PSD 112 may output an indication of a user input in response to detecting a user input. For instance, PSD 112 may output information about the user input to UI module 120.

Application modules 124 represent various individual applications and services that may be executed by computing device 110. One or more application modules 124 may cause computing device 110 to perform an action in response to receiving an indication of user input at a user interface (e.g., graphical user interface 114) associated with a particular application module 124. Examples of application modules 124 include a mapping or navigation application, a calendar application, an assistant application or prediction engine, a search application, a transportation service application (e.g., a bus or train tracking application), a social media application, a game application, an e-mail application, a messaging application, an Internet browser application, or any other application that may execute at computing device 110. In some examples, one or more application modules 124 may be installed at computing device 110 during production, testing, or otherwise at the time computing device 110 is manufactured and prior to being delivered to a user (e.g., consumer). In some examples, one or more application modules 124 may be installed by a user of computing device 110 after delivery to the user. For example, a user of computing device 110 may interact with ISS 117 to cause computing device 110 to download and install one or more application modules 124 (e.g., from an application repository).

UI module 120 manages user interactions with PSD 112 and other components of computing device 110. For example, UI module 120 may output a user interface and may cause PSD 112 to display the user interface as a user of computing device 110 views output and/or provides input at PSD 112. UI module 120 may receive one or more indications of input from a user as the user interacts with the user interfaces (e.g., PSD 112). UI module 120 may interpret inputs detected at PSD 112 and may relay information about the detected inputs (e.g., location, force, pressure, etc.) to one or more associated platforms, operating systems, applications, and/or services executing at computing device 110, for example, to cause computing device 110 to perform functions. For instance, UI module 120 may cause PSD 112 to display graphical user interface 114.

Graphical user interface 114 is a graphical user interface that provides access to one or more application modules 124. Graphical user interface 114 include graphical elements displayed at various locations of PSD 112. For example, as illustrated in FIG. 1, graphical user interface 114 includes a plurality of regions, including notification region 180, content region 182, and buttons region 184. Notification region 180 may display information such as notifications, date, time, cellular reception quality, battery status, etc. Buttons region 184 may include graphical elements to navigate between different graphical user interfaces, such as a “back” graphical element 186A, “home” graphical element 186B, and “recent” graphical element 186C. Content region 182 may include one or more graphical elements associated with various application modules 124. In some examples, content region 182 may include a graphical element 132A (e.g., an application icon) that corresponds to a single application module (e.g., a traffic application) of application modules 124. In some examples, content region 182 includes a graphical element 132B that corresponds to a plurality of application modules 124 (also referred to herein as a group of application modules 124). For instance, graphical element 132B (e.g., a folder icon), may correspond to a plurality applications (e.g., a music application, a weather application, a messaging application, or any combination of application modules 124).

UI module 120 may receive information and instructions from one or more associated platforms, operating systems, applications, and/or services executing at computing device 110 and/or one or more external computing systems (e.g., ISS 117). In addition, UI module 120 may act as an intermediary between the one or more associated platforms, operating systems, applications, and/or services executing at computing device 110, various output devices of computing device 110 (e.g., speakers, LED indicators, audio or electrostatic haptic output device, etc.) to produce output (e.g., a graphic, a flash of light, a sound, a haptic response, etc.) with computing device 110.

UI module 120 may receive an indication of user input at PSD 112 and may determine a type of user input. For example, UI module 120 may determine whether the user input includes a first type of user input or a second type of user input. The first type of input may be a “soft” press (e.g., a force or pressure of the input does not satisfy (e.g., is less than) a threshold force or pressure), a “short” press (e.g., a duration of the input does not satisfy a threshold duration or amount of time), etc. The second type of input may be a “hard” press (e.g., the force or pressure satisfies (e.g., is greater than) a threshold force or pressure), a “long” press, etc.

UI module 120 may determine whether the user input is a first type of input or a second type of input based on whether a value of a characteristic of the user input satisfies (e.g., is greater than or equal to) a threshold value. In some instances, the characteristic of the user input includes a force applied by the user input to computing device 110, a pressure applied by the user input to computing device 110, an amount of time the user input is applied to computing device 110 (also referred to as a duration of the user input and used to discern “short” press from “long” press), or a combination therein. The characteristic of the user input may include a speed of the input, direction of the input, shape of the input, etc. UI module 120 may determine that the type of input is a first type of input if the value of the characteristic does not satisfy (e.g., is less than) the threshold value. For example, UI module 120 may determine that the user input is a first type of input in response to determining that the force of the user input does not satisfy a threshold amount of force, the pressure of the user input does not satisfy a threshold amount of pressure, or the amount of time the user input was applied to computing device 110 (e.g., the duration of the user input) does not satisfy a threshold amount of time. In examples where the first type of input corresponds to a command to open a folder, if UI module 120 determines that the user input is a first type of user input, UI module 120 may output a plurality of graphical elements that each correspond to a respective application module of the plurality of application modules 124 in the folder. Said another way, UI module 120 may output a plurality of graphical elements that each represent a respective application module. For instance, UI module 120 may output a graphical user interface that includes a plurality of application icons and may cause PSD 112 to display the graphical user interface.

UI module 120 may determine that the type of input is a second type of input if the value of the characteristic of the user input satisfies (e.g., is greater than or equal to) a threshold value. In some examples, if UI module 120 determines that the user input is a second type of input, UI module 120 may send a message to action prediction module 122 indicating the user input is a second type of input.

UI module 120 may equate the type of user input with a particular command. For instance, UI module 120 may determine that the first type of input corresponds to a command to display the graphical elements (e.g., application icons) associated with the plurality of applications represented by graphical element 132B. In other words, in some examples, UI module 120 may determine that the first type of user input corresponds to a command to cause computing device 110 to open a folder icon and display a group of application icons that are located in the folder such that, when an individual application icon is selected by a user, the computing device executes a particular application module 124 associated the selected application icon.

In some examples, UI module 120 may determine that the second type of input corresponds to a command to display a graphical indication of a plurality of actions associated with at least one application module from the plurality of application modules 124. In other words, UI module 120 may determine that the second type of input corresponds to a command to display executable links to actions, that are associated with a group of application modules 124, that a user is most likely to want the computing device to execute upon selecting graphical element 132. That is, one or more application modules 124 may include one or more actions and the second type of input may correspond to a command to display a graphical indication of at least some of the actions. Each action in the plurality of actions may be an action to be performed by a respective application module during execution of the respective application module. For example, a particular application module (e.g., application module 124A) may be a messaging application module and may include, or may be configured to perform, actions such as “Send email,” “Text spouse” “Listen to unread voicemails,” etc. Similarly, another application module (e.g., application module 124B) may include a navigation application module and may include actions such as “Navigate Home”, “Navigate to Work”, etc. In some examples, the actions may be hard-coded by an application module developer. In some instances, the actions may he created and/or edited by a user. For example, a particular application module 124 may enable a user to record a macroinstruction (also referred to as a “macro”) and may store the macro as an action for later use.

Action prediction module (APM) 122 may determine a subset of one or more actions, from a plurality of actions that are associated with a group of application modules 124, that a user is more likely (relative to other actions) to cause computing device 110 to perform after selecting a graphical element (e.g., a folder icon) associated with the group of application modules 124. In response to UI module 120 determining that the user input is the second type of user input, APM 122 may cause UI module 120 to output a graphical user interface (e.g., graphical user interface 114) that includes a graphical element indicative of each respective action in the subset of actions.

APM 122 may determine one or more actions that are likely to be selected by a user of computing device 110. For example, APM 122 may determine a subset of actions from a plurality of actions associated with one or more application modules 124 represented by graphical element 132B. In some examples, APM 122 may determine which actions are more likely to be selected by determining an action relevancy score for each action and determining which actions have the highest action relevancy scores.

APM 122 may determine the action relevancy score for each corresponding action based on contextual information, such as action usage information. In some examples, APM 122 of computing device 110 may store action usage information associated actions. In some examples, APM 122 may obtain action usage information associated with actions being stored and provided by a remote computing system (e.g., a server, or other computing device). For instance, computing device 110 may be a mobile phone and APM 122 may obtain action usage information from a remote computing system, such as a tablet computer, a server, or the like, that is communicating with computing device 110 via network 116. APM 122 may only store information associated with users of computing device 110 if those users affirmatively consent to such collection of information. APM 122 may further provide opportunities for users to withdraw consent and in which case, APM 122 may cease collecting or otherwise retaining the information associated with that particular user. APM 122 may store the action usage information in any number of different data structures, such as a file, database, or other data structure.

In some examples, the action usage information may include information about how much each action in the plurality of actions is used. An action may be “used” when the action is selected or when the action is performed by the corresponding application module 124. Action usage information may include a respective counter associated with each action that indicates how many time the action has been selected by a user. In some instance, the action usage information may include an entry for each time that an action has been used by a user of computing device 110. For example, the action usage information may include a timestamp (e.g., date and time) for each time an action was used. In some examples, the action usage information includes usage information for a predefined time period (e.g., one week, one month, one year, etc.) and/or usage information for a predefined number of times an action was used. For example, the action usage information may include a timestamp for each time an action has been used in the last two months or a timestamp for each of the previous 100 times an action has been used.

In some examples, APM 122 may assign a higher action relevancy score corresponding to a particular action the more a user uses a particular action. For instance, if a user selects particular action (e.g., “Play Favorite Playlist”) associated with application module 124C (e.g., a music application module) more than a user selects a second action (e.g., “Text Spouse”) associated with application module 124A (e.g., a message application), APM 122 may assign a higher action relevancy score (e.g., 60 out of 100) to the action “Play Favorite Playlist” relative to the action score (e.g., 40 out of 100) assigned to the action “Text Spouse”. In some examples, a particular application module may include a plurality of actions. For instance, music application module 124C includes actions “Play Favorite Playlist” and “Play Other Favorite Playlist”.

APM 122 may determine the subset of actions based on the action relevancy score. For example, APM 122 may determine that the subset of actions includes a predetermined number or subset (e.g., three, five, etc.) of actions corresponding to the highest action relevancy scores. The predetermined number may be based on screen size, screen orientation, amount of pixel area available in a UI for displaying the actions, or other factors. In some examples, APM 122 may determine that the subset of actions includes actions where the corresponding action relevancy score satisfies (e.g., is greater than or equal to) a threshold relevancy score. In some examples, APM 122 may determine that the subset of actions includes the actions corresponding to the highest action relevancy scores, regardless of the application module 124 associated with each of the actions. In other words, in some examples, each action in the subset of actions may be associated with a single application module 124 if the action relevancy scores corresponding to those actions are the highest action relevancy scores. While described as assigning a higher relevancy score to more relevant actions, in some instances, APM 122 may assign a lower relevancy score the more a user utilizes a particular action, and may determine the subset of actions more likely to be selected by a user includes the actions corresponding to the lowest action relevancy scores.

In some examples, APM 122 may determine that the subset of actions may only include a predetermined number of actions associated with a given application module 124. In other words, in some examples, if music application module 124C includes actions (e.g., “Play Favorite Playlist”, “Play Other Favorite Playlist”, and “Play Third Favorite Playlist”) corresponding to the three highest action relevancy scores (e.g., 80 out of 100, 70 out of 100, and 60 out of 100, respectively), APM 122 may determine that the subset of actions includes the two actions (“Play Favorite Playlist” and “Play Other Favorite Playlist”) corresponding to the two highest scores associated with music application module 124C. In such examples, APM 122 may determine that the subset of actions includes an action of another application module 124 even if action relevancy score is not one of the highest action relevancy scores. For example, an action (e.g., “Check Hourly Forecast”) of application module 124D (e.g., a weather application) may correspond to the fifth highest action relevancy score, but may be included in a subset of four actions because the subset of actions may only include two actions for any particular application module 124.

In some examples, APM 122 may generate a graphical user interface (e.g., user interface 114) that includes a graphical indication of the subset of actions in response to determining the user input is a second type of user input. Graphical user interface 114 may include a plurality of graphical elements, such as action graphical elements 134-134D (collectively, “action graphical elements 134”). Each action graphical element 134 may represent a respective action in the subset of actions. For instance, as illustrated in the example of FIG. 1, action graphical element 134A represents the action “Play Favorite Playlist” via music application module 124C, action graphical element 134B represents the action “Check Hourly Forecast” via weather application module 124D, action graphical element 134C represents the action “Play Other Favorite Playlist” via music application module 124C, and action graphical element 134D represents the action “Text Spouse” via messaging application module 124A.

APM 122 may generate graphical user interface 114 and may output an indication of, or information about, graphical user interface 114 to UI module 120. UI module 120 may receive an indication of graphical user interface 114 and may cause PSD 112 to display graphical user interface 114 as shown in FIG. 1.

Computing device 110 may execute an action that corresponds to a selected action graphical element that is selected by additional user input. For example, PSD 112 may detect a user input selecting a particular action graphical element (e.g., graphical element 134A). UI module 120 may output an indication of the user input selecting graphical element 134A to music application module 124C. In response to receiving the indication of user input selecting graphical element 134A, music application module 124C may execute the action associated with the selected action graphical element 134A. In other words, music application module 124C may output an indication of the music included in the “Favorite Playlist” to UI module 120, which may cause computing device 110 to output audio data (e.g., a song).

In this way, the techniques of the disclosure may enable a computing device to predict and display graphical indications of a subset of actions that a user is more likely to cause the computing device to perform after the user selects a graphical element associated with a group of applications. By predicting actions the user is more likely to select and displaying selectable graphical indications of the predicted actions, the computing device may perform an action associated with a particular application in the group of applications in response to receiving fewer user inputs to cause the computing device to perform the action. Requiring fewer inputs to cause the computing device to perform an action may improve the user experience, enable faster operations, increase performance of the computing device, and/or decrease the electrical power consumed by computing device as compared to computing devices that require more user inputs to perform actions.

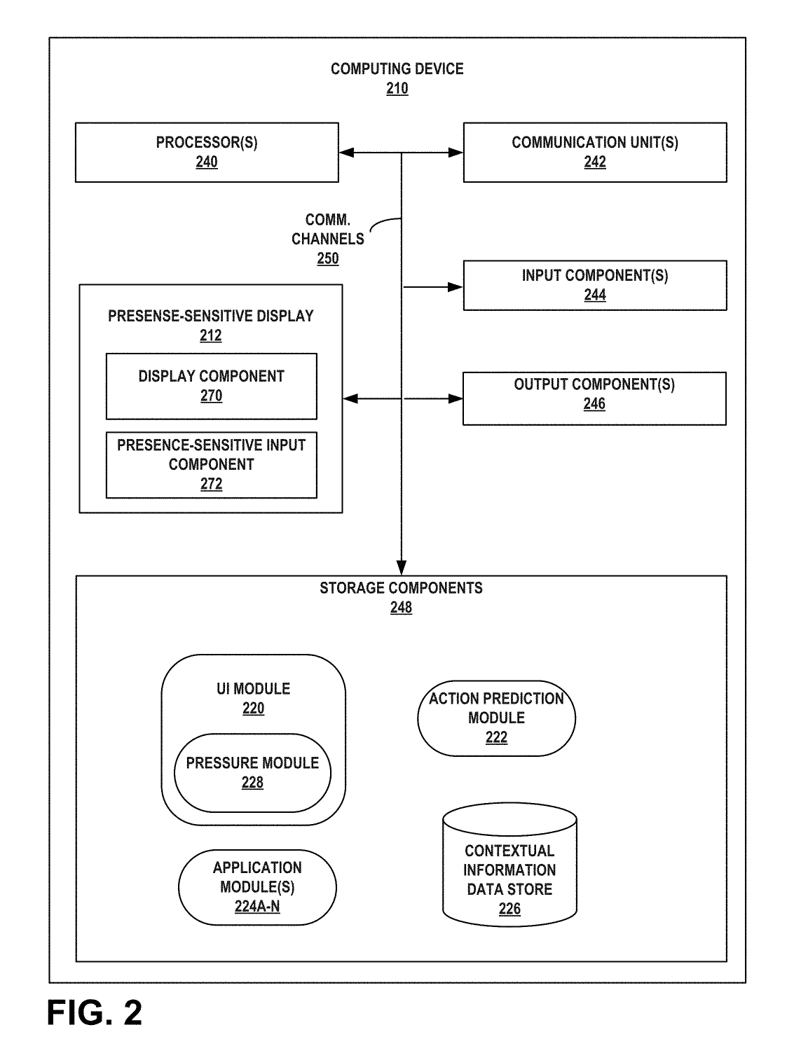

FIG. 2 is a block diagram illustrating an example computing device, that is configured to dynamically generate and display a subset of actions, in accordance with one or more aspects of the present disclosure. Computing device 210 of FIG. 2 is described below as an example of computing device 110 illustrated in FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes PSD 212, one or more processors 240, one or more communication units 242, one or more input components 244, one or more output components 246, and one or more storage components 248. PSD 212 includes display component 270 and presence-sensitive input component 272. Storage components 248 of computing device 210 may include UI module 220, action prediction module 222, one or more application modules 224A-N (collectively, “application modules 224”), and contextual information data store 226. UI module 220 may include pressure module 228.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive display, touch-sensitive screen, mouse, keyboard, voice responsive system, video camera, microphone, or any other type of device for detecting input from a human or machine. In some examples, input components 244 may include one or more sensor components one or more location sensors (GPS components, Wi-Fi components, cellular components), one or more temperature sensors, one or more movement sensors (e.g., accelerometers, gyros), one or more atmospheric pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 246 of computing device 210 may generate output. Examples of output are tactile, audio, and video output. Output components 246 of computing device 210 may include a presence-sensitive display, sound card, video graphics adapter card, speaker, cathode ray tube (CRT) monitor, liquid crystal display (LCD), or any other type of device for generating output to a human or machine.

PSD 212 of computing device 210 includes display component 270 and presence-sensitive input component 272. Display component 270 may be a screen at which information is displayed by PSD 212. Presence-sensitive input component 272 may detect an object at and/or near display component 270. As one example range, presence-sensitive input component 272 may detect an object, such as a finger or stylus that is within two inches or less of display component 270. In another example range, presence-sensitive input component 272 may detect an object six inches or less from display component 270 and other ranges are also possible. Presence-sensitive input component 272 may determine a location (e.g., an (x,y) coordinate) of display component 270 at which the object was detected. In some examples, PSD 212 may determine an amount of force or pressure applied at each (x,y) coordinate location. The force or pressure information may be represented as a depth component (z) that is part of the (x,y) location coordinates. Presence-sensitive input component 272 may determine the location of display component 270 selected by a user's finger using capacitive, inductive, and/or optical recognition techniques.

In some examples, presence-sensitive input component 272 also provides output to a user using tactile, audio, or video stimuli as described with respect to display component 270. In the example of FIG. 2, PSD 212 displays a graphical user interface. While illustrated as an internal component of computing device 210, PSD 212 may also represent an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging of computing device 210 (e.g., a monitor, a projector, etc. that shares a wired and/or wireless data path with a tablet computer).

One or more processors 240 may implement functionality and/or execute instructions within computing device 210. For example, processors 240 on computing device 210 may receive and execute instructions stored by storage components 248 that execute the functionality of modules 220, 222, 224, and 228. The instructions executed by processors 240 may cause computing device 210 to store information within storage components 248 during program execution. Examples of processors 240 include application processors, display controllers, sensor hubs, and any other hardware configure to function as a processing unit. Modules 220, 222, 224, and 228 may be operable by processors 240 to perform various actions, operations, or functions of computing device 210. For examples, processors 240 of computing device 210 may retrieve and execute instructions stored by storage devices 248 that cause processors 240 to perform the operations of modules 220, 222, 224, and 228. The instructions, when executed by processors 240, may cause computing device 210 to store information within storage devices 248.

One or more storage components 248 within computing device 210 may store information for processing during operation of computing device 210 (e.g., computing device 210 may store data accessed by modules 220, 222, 224, 228 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, and 228, as well as data store 226.

Application modules 224 may include the functionality of application modules 124 of computing device 110 of FIG. 1 and may perform similar operations as application modules 124. For example, one or more application modules 224 may cause computing device 210 to perform an action in response to receiving an indication of user input at a user interface (e.g., a graphical user interface) associated with a particular application module 224 (e.g., application module 224A). For instance, a particular application module (e.g., a messaging application 224A) may cause computing device 210 to send a text message to a remote computing device (e.g., remote computing device 118 of FIG. 1) via a communication unit 242 in response to receiving user input selecting a “send” key of a graphical user interface.

UI module 220 may include the functionality of UI module 120 of computing device 110 of FIG. 1 and may perform similar operations as UI module 120. For example, UI module 220 of computing device 210 may output a graphical user interface and may cause display component 270 of PSD 212 to display the graphical user interface. In some examples, the graphical user interface may include a graphical element (e.g., an application icon) that corresponds to a single application module of application modules 224. In some examples, the graphical user interface may include a single graphical element (e.g., a folder icon) that corresponds to a grouping of application modules 224.

PSD 212 may detect a user input and may send an information about the user input to UI module 220. The information may include one or more coordinate locations corresponding to the user input. The information about the user input may also include a timestamp indicating the time at which a user input was detected at each respective coordinate location. The information about the user input may also include force or pressure information indicating an amount of force or pressure applied at each respective coordinate location of PSD 212. The pressure information may be in the form of numerical, quantified data points (e.g., “0.73 units of force”) or discrete levels (e.g., “normal”, “hard”).

UI module 220 may receive the information about the user input from PSD 212 and may determine one or more other characteristics (e.g., force, pressure, direction, speed, etc.) of the user input. For example, UI module 120 may determine a start location of the user input, an end location of the user input, a density of a portion of the user input, a speed of a portion of the user input, a direction of a portion of the user input, and a curvature of a portion of the user input.

UI module 120 may determine whether the user input includes a first type of user input or a second type of user input. In some examples, the type of user input may be defined by a characteristic of the user input, such as force, pressure, duration, speed, direction, shape, etc. For example, the type of user input may be defined by force or pressure, such that the first type of user input may be a “soft” user input and the second type of user input may be a “hard” user input. As another example, the type of user input may be defined by duration of the user input, such that the first type of user input may be a “short” user input and the second type of user input may be a “long” user input.

UI module 220 may determine whether the user input is a first type of user input or a second type of user input based on one or more characteristics of the user input. For example, UI module 220 may determine that the user input is a first type of user input in response to determining that a value of a particular characteristic of the user input does not satisfy (e.g., is less than) a threshold value for the particular characteristic. For instance, pressure module 228 of UI module 220 may determine the user input is a first type of user input (e.g., a “soft” input) when the pressure of the user input is less than a threshold amount of pressure. In contrast, UI module 220 may determine the user input is a second type of user input in response to determining the value of the particular characteristic satisfies (e.g., is greater than) the threshold value of the particular characteristic. For instance, pressure module 228 of UI module 220 may determine the user input is a second type of input (e.g., a “hard” input) in response to determining that the value of the pressure of the input is greater than the threshold amount of pressure. In some instances, the threshold is also referred to as a “display-actions” threshold. For instance, when pressure module 228 of UI module 220 determines the pressure of the user input satisfies the “display-actions” threshold amount of pressure, APM 222 may cause UI module 220 to display a plurality of actions.

In some examples, the first type of user input corresponds to a first command and the second type of user input corresponds to a second command. For instance, the first type of user input may correspond to a command to display the graphical elements associated with a plurality of application modules. The second type of user input may correspond to a command to display a graphical indication of a plurality of actions associated with at least one application module from application modules 224.

In response to determining that the user input is a first type of user input, UI module 220 may cause computing device 210 to execute the first command. For example, if PSD 212 detects a first type of user input at a location of display presence-sensitive input component 270 corresponding to a single graphical element that corresponds to grouping of a plurality of application modules 224, UI module 220 may cause PSD 212 to display graphical elements associated with a group of application modules 224 represented by the single graphical element. Stated another way, in some instances, when UI module 220 determines the user input selecting a folder icon is a first type of user input, UI module 220 may output graphical user interface that includes a plurality application icons associated with the plurality of application modules 224. In some examples, after displaying the application icons associated with each respective application module in the group of application modules 224, PSD 212 may detect a user input selecting an individual application icon. UI module 220 may receive an indication of the user input selecting the individual application icon, such that computing device 210 may execute the application module associated with the selected application icon.

In response to receiving a user input selecting the single graphical element 132B that corresponds to a group of application modules 224 and determining that the user input is a second type of user input, computing device 210 may execute the second command corresponding to the second type of user input. For example, UI module 220 may execute the command by updating graphical user interface 114 to include a graphical indication of one or more actions associated with the application modules 224 corresponding to the single graphical element 132B. Stated differently, in some examples, in response to detecting a “hard” or “long” user input selecting folder icon 132B, UI module cause PSD 2112 to display a graphical indication of a subset of actions that may be performed by at least one of the application modules 224 represented by folder icon 132B.

APM 222 may determine a subset of one or more actions, from a plurality of actions associated with a group of application modules 224 corresponding to graphical element 132B, that a user is more likely to select, relative to other actions, and to cause computing device 110 to perform, after selecting the graphical element 132B. In some instances, a user may specify which actions to include in the subset of actions (e.g., by adjusting settings associated with graphical element 132B, which may be a folder icon), and APM 222 may determine the subset of actions based on the user specified settings. As another example, APM 222 may determine the subset of actions by selecting actions in alphabetical order (e.g., alphabetical by action name or by the application module associated with the action), or in the order that the application modules 224 were added to graphical element 132B.

APM 222 may dynamically customize the subset of actions to display at PSD 212 for a particular user account of computing device 210. For example, computing device 210 may be configured with one or more user accounts where a particular user account from the one or more configured user accounts may be active when the user input selecting the single graphical element (e.g., graphical element 132B of FIG. 1) is detected. APM 222 may determine which user account is the active user account and may automatically determine the subset of actions that are likely to be selected by the active user of computing device 210.

APM 222 may determine the subset of actions that are likely to be selected based on an action relevancy score for each action in the plurality of actions. APM 222 may determine the action relevancy score corresponding to each action in the plurality of actions based on contextual information. Contextual information may be stored at computing device 210 or may be accessible to computing device 210 while being stored at a remote computing device (e.g., a server or the like). Computing device 210 may store contextual information in contextual information data store 226 only if the user affirmatively consents to storing data. Computing device 210 may cease collecting and storing contextual information in response to the user withdrawing consent. Contextual information data store 226 may include one or more files, tables, or databases that store contextual information.

As used throughout the disclosure, the term “contextual information” is used to describe information that can be used by a computing system and/or computing device, such as computing device 210 to define one or more environmental characteristics associated with computing device 210 and/or users of computing device 210. In other words, contextual information represents any data that can be used by a computing device and/or computing system to determine a “user context” indicative of the circumstances that form the experience the user undergoes (e.g., virtual and/or physical) for a particular location at a particular time. Contextual information may include action usage information. The action usage information may include information about how much (e.g., how often, for how long a duration, etc.) each action in a plurality of actions is performed by computing device 210 or by a group of remote computing devices. Contextual information may include application usage information, which may indicate how much (e,g., how often, for how long a duration, etc.) a user of computing device 210 and/or a group of remote users interact with applications installed at computing device 210. In some examples, contextual information includes movement and position information. Movement and position information may include past, current, and future physical locations, degrees of movement, magnitudes of change associated with movement, patterns of travel, patterns of movement, elevation, etc. Contextual information may include user history information, such as purchase histories, Internet browsing histories, search histories (e.g., internet searches, searches of computing device 110, or both), and the like. In some examples, contextual information includes local environmental conditions, such as date, time, weather conditions, traffic conditions, or the like. Contextual information may also include communication information such as information derived from e-mail messages, text messages, voice mail messages or voice conversations, calendar entries, task lists, social media network related information. Contextual information may include any other information about a user or computing device that can support a determination of a user context.

APM 222 may determine an action relevancy score corresponding to each action in the plurality of actions based on action usage information. The action usage information may include a counter associated with each action, where the counter indicates how many times each respective action has been used within a predefined amount of time. The action usage information may include an entry for each time that an action is performed by computing device 210. For example, the action usage information may include a timestamp (e.g., date and time) indicating each time a respective action has been performed. In some examples, the action usage information includes action usage information for a predefined time period (e.g., one week, one month, one year, etc.) and/or action usage information for a predefined number of actions. For example, the action usage information may include a timestamp for each time an action has been performed in the last two months or a timestamp for the previous 100 times the action has been performed. APM 222 may query contextual information data store and may receive, as a result of the query, to determine how much the user of computing device 210 uses each action in the plurality of actions.

In some examples, APM 222 assigns a higher action relevancy score to actions that have been performed more recently. For example, if the action “Text Spouse” associated with messaging application 224A was used more recently than the action “Navigate Home” associated with navigation application 224B, APM 222 may assign a higher action relevancy score to the action “Text Spouse” relative to the action relevancy score assigned to the “Navigate Home” action. In some instances, APM 222 may assign a higher action relevancy score the more the user utilizes a particular action. For instance, if the user sends a text message to the user's spouse every day, APM 222 may assign a high action relevancy score (e.g., 90 out of 100). However, if the user listens to a particular playlist only once a month, APM 222 may assign a low (e.g., 10 out of 100) action relevancy score. In other words, the more a user has used a particular action of an application module, APM 222 may determine the user is more likely to use the particular action in the future.

APM 222 may determine an action relevancy score corresponding to a particular action based on application usage information. In some examples, APM 222 may assign a higher action relevancy score to actions of a particular application module of application modules 224 the more recently the particular application module has been used. In other words, in some instance, if music application module 224C was used more recently than weather application module 224D, APM 222 may assign a higher action relevancy score to the actions associated with music application 224C relative to the action relevancy score corresponding to the actions of weather application 224D. APM 222 may assign a higher action relevancy score to one or more actions of a particular application module the more the user interacts with the particular application module. APM 222 may determine an initial action relevancy score based on action usage information, and may modify the action relevancy score based on application usage information. For instance, APM 222 may determine that the initial action relevancy score corresponding to the action “Play Favorite Playlist” of music application 224C is equal to the initial action relevancy score corresponding to the action “Check Hourly Forecast” of weather application 224D, and that the application usage information indicates the user interacts with music application 224C more than the user interacts with weather application module 224D. As a result, APM 222 may assign adjust (e.g., increase) the action relevancy score corresponding to the action “Play Favorite Playlist” by increasing the action relevancy score.

APM module 222 may determine the subset of actions based at least in part on an external factor as the external factor affects an amount of use, by an active user of the computing device, of each action in the plurality of actions. In other words, APM 222 may determine an action relevancy score corresponding to a particular action based on other factors such as time of day, location, weather, or other external parameters.

For example, for a particular time of day, location, weather condition, etc. APM 222 may assign a higher action relevancy score to actions of a particular application module of application modules 224 whereas for a different time of day, location, weather condition, etc. APM 222 may assign a higher action relevancy score to actions of a different application module of application modules 224. In some cases, APM 222 may typically assign a particular application module of application modules 24 with a lower action relevancy score as a user may almost never use that particular application. However, whenever a user is at a particular location, as infrequently as that may be, the user may use the particular application with high frequency. Therefore, in response to determining that computing device 210 is at the particular location, APM module 222 may assign the particular application module with a higher action relevancy score. In some cases, at certain times of day, APM 222 may typically assign a particular application module of application modules 24 with a lower action relevancy score as a user may almost never use that particular application at those certain times of day. However, whenever a user uses applications at a particular time of day, as infrequently as that may be, the user may use the particular application at the particular time of day, with high frequency. Therefore, in response to determining that it is approximately the particular time of day at which the user, if he or she were to use an application would use the particular application, APM module 222 may assign the particular application module with a higher action relevancy score.

In some examples, APM 222 may determine the action relevancy score corresponding to a particular action associated with a particular application module 224 (e.g., a first messaging application 224A) based on one or more other application modules corresponding to graphical element 132B (e.g., a second messaging application module 224E). For example, APM 222 may determine whether a particular application module of is similar to another application module of application modules 224. A first application module may be similar to a second application module if the first application module includes functionality that is similar to the functionality of the second application. In other words, two application modules may be similar if the application modules include similar actions. For instance, a first messaging application module 224A may be similar to a second messaging application module 224E when both application modules include actions to send messages (e.g., text, email, etc.). Similarly, a first weather application module 224D may be similar to a second weather application module 224F when both application modules include actions related to the weather (e.g., display forecasts, radar, etc.). In some instances, APM 222 may determine whether two application modules are similar by querying metadata (e.g., a description provided by a developer of each respective application module, or user comments in cloud based application repository) and determining whether each application module includes a similar description or a certain number of similar keywords.

In some examples, in response to determining that the first messaging application module 224A is similar to the second messaging application module 224E, APM 222 may assign a higher action relevancy score to more specific actions associated with the respective application modules 224A, 224E. For instance, a single graphical element 132B may correspond to first text messaging application module 224A and second text messaging application module 224E. A user of computing device may tend to message certain individuals with text message application module 224A and other individuals with text message application module 224E. When the single graphical element 132B corresponds to both text message application modules 224A and APM 222 may assign a higher action relevancy score to the specific actions such as “Text Spouse via application module 224A” and “Text Boss via application module 224E”, as compared to a more generic action such as “Create a text message,” in this way, when a single graphical element 132B corresponds to two or more similar application modules 224, APM 222 may assign action relevancy scores to more specific actions to more accurately differentiate between the actions the user is likely to select for each of the similar application modules.

APM 222 may determine an action relevancy score based at least in part on movement and position information instance, APM 222 may determine that computing device 210 is located a particular location (e.g., work) based on location sensors, such as GPS components or WiFi component (e.g., via IP address), and may query contextual information data store 226 to determine which actions the user causes computing device 210 to perform most often at the particular location. Thus, in some examples, APM 222 may assign higher action relevancy score to actions performed most often at the particular location.

APM 222 may, in some examples, determine an action relevancy score corresponding to a particular action based on a group of users (e.g., a group of users of remote computing devices 118 of FIG. 1) that are similar to an active user of computing device 210. The active user may be similar to other users who are a similar age (e.g., plus or minus five years, ten years, etc.), live in a similar location (e.g., same city, state, country, etc.), have similar application modules installed on computing device 210, or have other characteristics in common. In some instances, application module 224A may determine how much (e.g., an amount of usage) similar users utilize each action in the plurality of actions by querying a cloud computing system (e.g., ISS 117 of FIG. 1). In response to the query, APM 222 may receive action usage information from ISS 117 indicating how much the similar users utilize the actions in the plurality of actions that are associated with the group of application modules 224 that correspond to the single graphical element 132B. In some examples, APM 222 may assign a higher action relevancy score to a particular action the more a group of similar users utilize the particular action. For instance, the active user may be more likely to use a particular action the more a group of similar users also utilize the particular action.

In some instances, APM 222 determines the subset of actions based at least in part on the corresponding action relevancy scores. APM 222 may determine the subset of actions includes a predetermined number of actions. In other words, APM 222 may be configured to select a predetermined number (e.g., N, where N is any integer) of actions and may select, as the subset of actions, the actions corresponding to the N largest action relevancy scores. APM 222 may determine the subset of actions includes the actions where the corresponding action relevancy score satisfies (e.g., is greater than) a threshold relevancy score.

APM 222 may determine the subset of actions based at least in part on a value of the characteristic of the user input. For example, the characteristic of the user input may be pressure, such that APM 222 may determine the subset of actions based on a value of the pressure of the user input. For instance, APM 222 may compare the value of the pressure to a “determine action” threshold amount of pressure and may determine the subset of actions based on the comparison of the pressure to the “determine action” threshold amount of pressure. The “determine actions” threshold may be a larger amount of pressure than the “display-actions” threshold amount of pressure discussed above.

In response to determining the value of the pressure satisfies (e.g., is greater than or equal to) the “display-actions” threshold amount of pressure and does not satisfy (e.g., is less than) a “determine actions” threshold amount of pressure, APM 222 may determine the subset of actions includes a first subset of actions. In contrast, in response to determining that the value of the pressure satisfies the “display-actions” threshold amount of pressure and also satisfies the “determine actions” threshold amount of pressure, APM 222 may determine the subset of actions includes a second threshold of actions. In other words, if the pressure of the user input is larger than the “display-actions” threshold amount of pressure, APM 222 may determine a subset of actions to display, and the subset of actions that APM 222 determines to display may depend upon whether the value of the pressure is greater than a “determine action” threshold. For instance, when the user applies one amount of pressure to PSD 212, APM 222 may determine the subset of actions includes the N (e.g., three) actions corresponding to N highest (e.g., 1^{st}-3^{rd}) action relevancy scores, and when the user applies a different (e.g., larger) amount of pressure to PSD 212, APM 222 may determine the subset of actions includes actions corresponding to the next N highest (e.g., 4^{th}-6^{th}) action relevancy scores. While the characteristic of the user input is described as a pressure of the user input, the characteristic of the user input may be a force, duration, speed, direction, shape, etc., and each of the various thresholds may be a threshold force, duration, length, etc. In this way, computing device 210 may output different subsets of actions, which may increase the number of actions that may be presented to a user, based on different amounts of pressure or different values of a particular characteristic. Enabling the computing device 210 to output different sets of actions may enable a user to cause computing device 210 to perform more actions without entering numerous user inputs.

In response to determining the subset of actions, APM 222 may generate a graphical user interface (e.g., graphical user interface 114 of FIG. 1) that includes one or more action graphical elements 134 that each correspond to a respective action in the subset of actions. APM 222 may output an indication of graphical user interface 114 to UI module 220, which may cause display component 270 of PSD 212 to display graphical user interface 114.

In some examples, the user of computing device 210 may continue to apply the user input to PSD 212 of computing device 210 while PSD 212 displays graphical user interface 114. While displaying graphical user interface 114, PSD 212 may detect a change in the value of the characteristic of the user input. For instance, the user may select graphical element 132B by pressing a finger against PSD 212, and as PSD 212 displays initial action graphical elements 134, the user may vary the amount of pressure applied to PSD 212. PSD 212 may detect a change in the characteristic (e.g., pressure) of the user input while displaying an initial plurality of action graphical elements 134. UI module 220 may receiving an indication of a different, updated value of the characteristic of the user input, and may send an indication of the updated value to APM 222. APM 222 may determine, based on the updated value of the characteristic, a second subset of actions. In other words, in response to determining that the value of the characteristic changed (e.g., increased), APM 222 may determine a second subset of actions and may send an indication of the second subset of actions to UI module 220. UI module 220 may receive the indication of the second subset of actions and may cause PSD 212 to output a graphical indication of the second subset of actions. Said another way, UI module 220 may cause PSD 212 to display a graphical user interface that includes action graphical elements associated with the actions in the second subset of actions. By outputting different subsets of actions in response to detecting a change in the value of the characteristic of the user input, computing device 210 increase the number of actions displayed by PSD 212, which may enable a user to cause computing device 210 to perform more actions without entering numerous user inputs.

PSD 212 may detect a user input selecting a particular action graphical element of action graphical elements 134. In response to receiving an indication of the user input selecting the particular action graphical element, computing device 210 may execute an action that corresponds to the particular action graphical element. For instance, PSD 212 may detect a user input selecting action graphical element 134D, and may execute an action corresponding to action graphical element 134D by displaying a graphical user interface associated with messaging application 224A. For instance, messaging application 224A may prepopulate the recipient information (e.g., a “To:” field) with the contact information for the user's spouse.

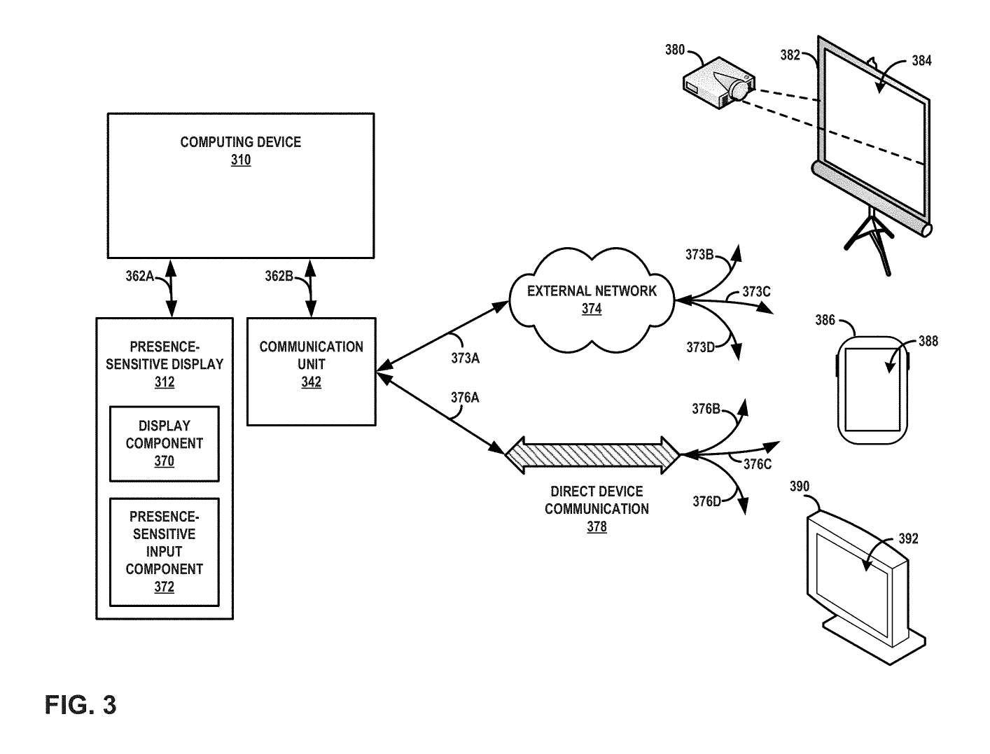

FIG. 3 is a block diagram illustrating an example computing device that is configured to dynamically generate and display a subset of actions for display at a remote device, in accordance with one or more techniques of the present disclosure. Graphical content, generally, may include any visual information that may be output for display, such as text, images, and a group of moving images, to name only a few examples. The example shown in FIG. 3 includes a computing device 310, a PSD 312, communication unit 342, projector 380, projector screen 382, mobile device 386, and visual display component 390. In some examples, PSD 312 may be a presence-sensitive display as described in FIGS. 1-2. Although shown for purposes of example in FIGS. 1 and 2 as a stand-alone computing device 110 and 210 respectively, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing devices 110 and 210 in FIGS. 1-2 respectively, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 370 and presence-sensitive input component 372. Display component 370 may, for example, receive data from computing device 310 and display the graphical content. In some examples, presence-sensitive input component 372 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 372 may be physically positioned on top of display component 370 such that, when a user positions an input unit over a graphical element displayed by display component 370, the location at which presence-sensitive input component 372 corresponds to the location of display component 370 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth, cellular, and WiFi radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates a projector 380 and projector screen 382. Other such examples of projection devices may include electronic whiteboards, holographic display components, and any other suitable devices for displaying graphical content. Projector 380 and projector screen 382 may include one or more communication units that enable the respective devices to communicate with computing device 310. In some examples, the one or more communication units may enable communication between projector 380 and projector screen 382. Projector 380 may receive data from computing device 310 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 310. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 112, 212, and/or 312 as described in this disclosure. In some examples, presence-sensitive display 384 may include additional functionality. Projector screen 382 (e.g., an electronic whiteboard), may receive data from computing device 310 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 310.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other semi-stationary devices such as televisions, computer monitors, etc. As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such as projector 380, projector screen 382, mobile device 386, and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as projector 380, projector screen 382, mobile device 386, and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, 373C, or 373D. External network 374 may include network hubs, network switches, network routers, etc., that are operatively inter-coupled thereby providing for the exchange of information between computing device 310 and the remote devices illustrated in FIG. 3. In some examples, network links 373A-373D may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth, Near-Field Communication, Universal Serial Bus, WiFi, infrared, etc. One or more of the remote devices illustrated in FIG. 3 may be operatively coupled with computing device 310 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, computing device 310 may output a graphical user interface that includes a single graphical element that corresponds to a plurality of applications. Computing device 310 may send data, via communication unit 342 and external network 374, that includes a representation of the graphical user interface to communication unit 342. Visual display component 390 may receive the data and, in response to receiving the data, may cause PSD 392 to output the graphical user interface. In response to receiving a user input at PSD 392 selecting the single graphical element, visual display component 390 may send an indication of the user input to computing device 310 using external network 374. Communication unit 342 of may receive the indication of the user input, and send the indication to computing device 310.

Computing device 310 may determine whether the user input is a first type of user input or a second type of user input. In sonic examples, computing device 310 may determine the type of user input based on a value of a characteristic (e.g., force, pressure, duration, etc.) of the user input. Responsive to determining that the user input is a first type of input, computing device 310 may output a plurality of graphical elements, where each graphical element corresponds to a respective application from the group of applications corresponding to the single graphical element. In other words, when the single graphical element is a folder icon that corresponds to a plurality of applications and the user input selecting the folder icon is a first type of input, computing device 310 may output a plurality of application icons, where each application icon is associated with one of the applications in the plurality of applications. Computing device 310 may determine a subset of actions, from a plurality of actions associated with the plurality of applications, that are more likely to be selected by a user of computing device 310 than other actions not in the subset. In some examples, responsive to determining that the user input is a second type of input, computing device 310 may output a graphical indication of the subset of actions. In other words, when the single graphical element is a folder icon that corresponds to a plurality of applications and the user input selecting the folder icon is a second type of input, computing device 310 may update the graphical user interface to include a plurality of action graphical elements, where each action graphical element corresponds to a respective action in the subset of actions.

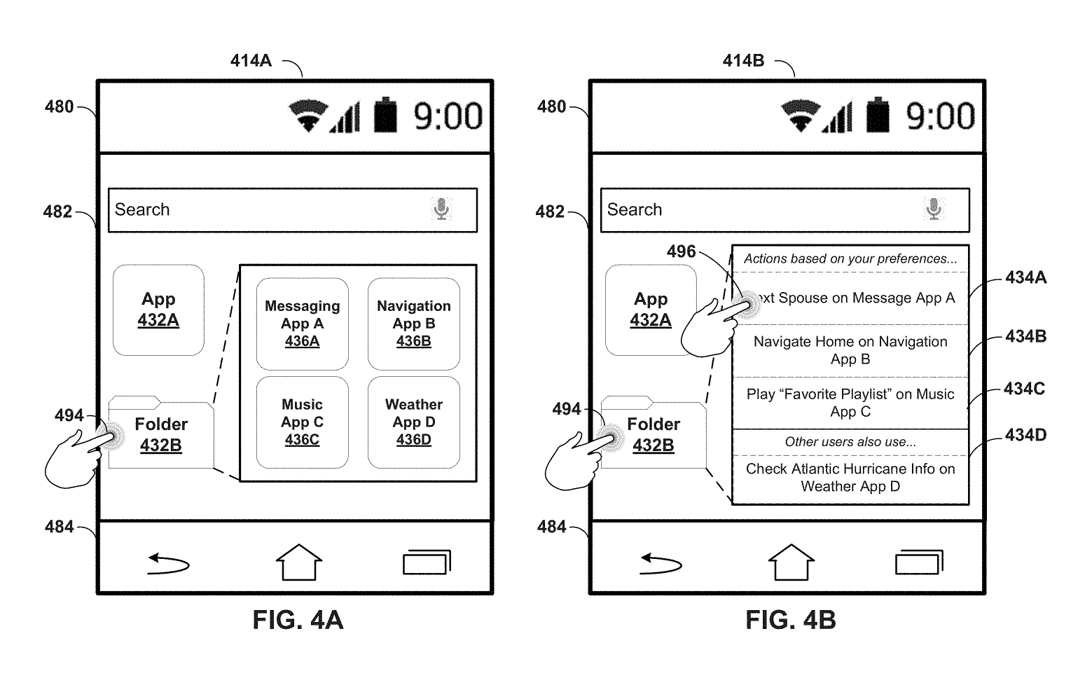

FIGS. 4A-4B are conceptual diagrams illustrating example graphical user interfaces of an example computing device that is configured to dynamically generate and display a subset of actions, in accordance with one or more aspects of the present disclosure. FIGS. 4A-4B illustrate, respectively, example graphical user interfaces 414A-414B (collectively, graphical user interfaces 414). However, many other examples of graphical user interfaces may be used in other instances. Each of graphical user interfaces 414 may correspond to a graphical user interface output by computing device 110 of FIG. 1. As illustrated in the examples of FIGS. 4A-4B, each example graphical user interface 414 includes notification region 480, content region 482, and buttons region 484, which may correspond to notification region 180, content region 182, and buttons region 184 of FIG. 1, respectively.

FIG. 4A is a conceptual diagram illustrating an example graphical user interface 414A generated by computing device 110 in response to determining a user input is a first type of user input. For example, PSD 112 may detect a user input at a location of PSD 112 at which graphical element 432B is displayed. For instance, PSD 112 may detect a first user input at location 494. As shown in FIG. 4A, graphical element 432B may be a single graphical element that corresponds to a group of a plurality of application modules 124. UI module 120 of computing device 110 may determine based on the location of the user input that the user input selects graphical element 432B and further may determine that the user input is a first type of user input based on a value of a characteristic (e.g., force, pressure, duration, speed, etc.) of the user input. For example, UI module 120 may determine that the user input is a first type of user input in response to determining that the value of the characteristic does not satisfy (e.g., is less than) a threshold value for that characteristic. In response to determining that the user input is a first type of user input, UI module 120 may output a plurality of graphical elements, such as application icon graphical elements 436A-436D (collectively, “application icon graphical elements 436). In some instances, each application icon graphical element 436 corresponds to a respective application module of the plurality of application modules 124. A user may select a particular application icon graphical element 436, such that computing device 110 may execute the application module 124 associated with the selected application icon graphical element 436.

FIG. 4B is a conceptual diagram illustrating an example graphical user interface 414B that includes dynamically generated subsets of actions, which are displayed by computing device 110 in response to determining a user input is a second type of user input.

As described with reference to FIG. 1, one or more of application modules 124 corresponding to graphical element 132B may include at least one action that may be executed by computing device 110 during execution of the respective application module. For instance, a messaging application module 124A may include the action “Text Spouse,” a navigation application module 124B may include the action “Navigate Home”, a music application module 124C may include the action “Play ‘Favorite Playlist’,” and a weather application module 124D may include the action “Check Atlantic Hurricane Information.” APM 122 may determine, from the plurality of actions associated with application modules 1241-124D, a subset of actions more likely to be selected by the user of computing device 110 than other actions in the plurality of actions. In some examples, APM 122 may determine the subset of actions based at least in part on action usage information that indicates how much the active user of computing device 110 utilizes the actions in the plurality of actions. For instance, APM 122 may determine that the user frequency uses the actions “Text Spouse,” “Navigate Home,” and “Play Favorite Playlist,” and may include these actions in the subset of actions.

APM 122 may determine one or more actions to include in the subset of actions based on action usage information associated with a group of users that are similar to the active user. For instance, APM 122 may determine that a group of similar users (e.g., users that are also located in Florida) frequently use the action “Check Atlantic Hurricane Info.” Thus, APM 122 may determine the subset of actions includes the action “Check Atlantic Hurricane Info” of weather application module 124D, even if the action usage information for the active user does not indicate the user is more likely to select this action over other actions. In this way, APM 122 may tailor the actions in the subset of actions based on the active user, and may also recommend additional actions that the active user hasn't used but which may be of interest to the active user.

As described above, PSD 212 may detect a first user input at a location of PSD 112 at which graphical element 432B is displayed. For instance, PSD 112 may detect a first user input at location 494 of PSD 212. UI module 120 may determine that the first user input selects graphical element 432B based on the location 494 of the user input. UI module 120 may also determine that the user input is a second type of user input. For instance, UI module 120 may determine the user input is a second type of user input in response to determining that the value of the characteristic satisfies (e.g., is greater than or equal to) a threshold value for that characteristic. In response to determining that the user input is a second type of user input, UI module 120 may output a plurality of graphical elements, such as action graphical elements 434A-434D (collectively, “action graphical elements 434). In some instances, each action graphical element 434 corresponds to a respective action in the subset of actions.

Responsive to outputting the plurality of action graphical elements 434, PSD 112 may detect a second user input at a location 496 of PSD 112 at which action graphical element 434A is displayed. PSD 112 may determine the second user input selects action graphical element 434A based on the location 496 of the second user input. Responsive to determining the second user input selects action graphical element 434A, computing device 110 may execute the action corresponding to the associated with the selected application icon graphical element 434. For instance, computing device 110 may cause a music application associated with action graphical element 434A to play a playlist entitled “Favorite Playlist.”

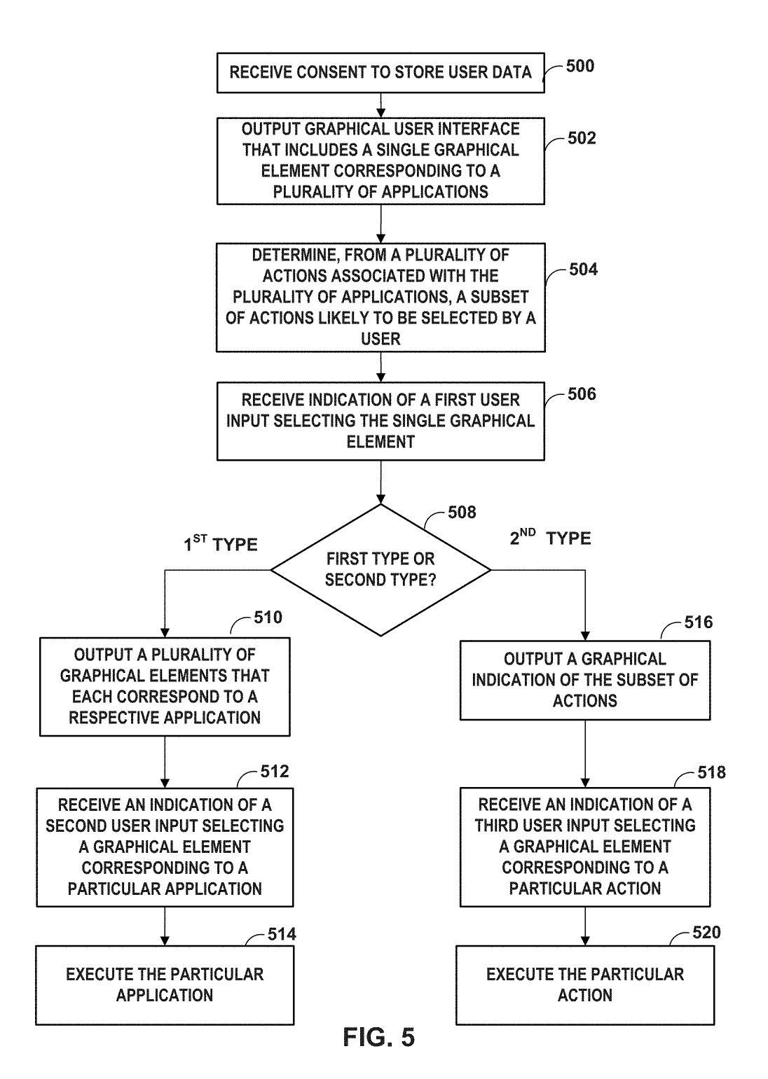

FIG. 5 is a flowchart illustrating example operations of a computing device that is configured to dynamically generate and display a subset of actions, in accordance with one or more aspects of the present disclosure. The process of FIG. 5 may be performed by one or more processors of a computing device, such as computing devices 110 and 210 as illustrated in FIG. 1 and FIG. 2, respectively. For purposes of illustration only, FIG. 5 is described below within the context of computing device 110 and 210 of FIG. 1 and FIG. 2, respectively, and graphical user interfaces 114, 414 of FIG. 1 and FIG. 4, respectively.

Computing device 110 may receive consent to store user data (500). Computing device 110 may only store information associated with a user of computing device 110 if the user affirmatively consents to such collection of information. Computing device 110 may further provide opportunities for the user to withdraw consent and in which case, computing device 110 may cease collecting or otherwise retaining the information associated with that particular user. Responsive to receiving user consent to store user data, computing device 110 may store contextual information, such as action usage information and/or application usage information, in contextual information data store 226.

Computing device 110 may output a graphical user interface that includes a single graphical element corresponding to a plurality of applications (502). For instance, graphical element 432B of graphical user interfaces 414 may include a folder icon that corresponds to a plurality, or group, of application modules 124. In some instances, graphical user interfaces 414 may also include a graphical element (e.g., an application icon) 432A corresponding to a single application module 124.

In some examples, APM 122 of computing device 110 determines, from a plurality of actions associated with the plurality of application modules, a subset of actions that are more likely to be selected, by a user, than other actions that are not part of the subset (504). For example, the group of application modules 124 may include, or be configured to perform, a group of one or more actions. APM 122 of computing device may assign a relevancy score to each respective action in the plurality of actions, and may determine which actions to include in the subset based on the respective relevancy scores. In some examples, APM 122 assigns a higher relevancy score to a particular action the more the active user of computing device 110 uses the particular action, the more the active user utilizes a particular application module associated with the particular action, the more a group of users similar to the active user utilize the particular action, or a combination therein.

PSD 112 of computing device 110 may detect a tactile user input (e.g. a tactile user input) selecting the single graphical element 432B and may output an indication of the user input (e.g., data, or information, about the user input) to UI module 120. UI module 120 of computing device 110 may receive an indication of a user input selecting the single graphical element 432B (506).

Responsive to receiving the indication of user input, UI module 120 of computing device 110 may determine whether the user input is a first type of user input or a second type of user input (508). For example, UI module 120 may determine whether the user inputs is a “hard” user input or a “soft” user input. As another example, UI module 120 may determine whether the user input is a “long” user input or a “short” user input. UI module 120 may determine the type of input by comparing a value of a characteristic (e.g., pressure, force, duration, speed, etc.) of the user input to a threshold value, also referred to as a “display-actions” threshold value. For example, UI module 120 may determine that the information about the user input indicates the pressure value equals a certain value of pressure, and may compare the pressure value to a “display-actions” threshold value.

UI module 120 may determine the user input is a first type of user input in response to determining the value of the characteristic of the user input does not satisfy the “display-actions” threshold. For instance, if the pressure value equals 0.5 units of pressure and the “display-actions” threshold amount of pressure equals 1.0 units of pressure, UI module 120 may determine that the value of the pressure does not satisfy (e.g., because the value of the pressure is less than) the “display-actions threshold amount of pressure. Thus, UI module 120 may determine the user input is a first type of user input.

In some examples, UI module 120 may determine the user input is a second type of user input in response to determining the value of the characteristic of the user input satisfies the “display-actions” threshold. For instance, if the pressure value equals 2.0 units of pressure and the “display-actions” threshold amount of pressure equals 1.0 units of pressure, UI module 120 may determine that the value of the pressure satisfies (e.g., because the value of the pressure is greater than) the “display-actions” threshold amount of pressure. Thus, UI module 120 may determine the user input is a second type of user input. As described in more detail later, in some instances, when UI module 120 determines the value of the characteristic of the user input satisfies the “display-actions” threshold, UI module 120 may cause PSD 212 to display a plurality of actions.

If the user input is a first type of user input (“1^{st} type” branch of 508), computing device 110 may output a plurality of application graphical elements that each correspond to a respective application of the plurality of applications (510). For example, as illustrated in FIG. 4A, graphical user interface 414A may include a group of application icons 436, where each application icon is associated with a respective application module of application modules 124.

Computing device 110 may receive an indication of a second user input selecting a particular application graphical element of the plurality of application graphical elements (512). For example, PSD 212 may detect a second user input selecting graphical element (e.g., application icon) 436D, and may output an indication of the selection to UI module 120. UI module 120 may receive the indication of the selection of graphical element 436D and may determine the user input corresponds to a selection of graphical element 436D. Computing device 110 may execute the particular application corresponding to the selected application graphical element (514). For instance, in response to determining the user input corresponds to a selection of graphical element 436D, UI module 120 may cause computing device 110 to execute a weather application module corresponding to graphical element 436D.

If the user input is a second type of user input (“2^{nd} type” branch of 508), computing device 110 may output a graphical indication of the subset of actions (516). APM 122 may generate graphical user interface 414B, which may include action graphical elements 434. Each action graphical element 434 may correspond to a respective action in the subset of actions.

Computing device 110 may receive an indication of a third user input selecting a particular action graphical element from the plurality of action graphical elements (518). For example, PSD 112 may detect a third user input at a location of PSD 112 corresponding to action graphical element 434C. PSD 112 may output information about the third user input to UI module 120. UI module 120 may receive the information about the third user input and may determine the third user input corresponds to a selection of action graphical element 434C. Computing device 110 may execute the action corresponding to the selected action graphical element (520). For example, in response to determining the third user input corresponds to a selection of action graphical element 434C, UI module 120 may determine that action graphical element 434C corresponds to the action “Play Favorite Playlist” via a music application module, and may cause an output component (e.g., a speaker) to play audio data (e.g., music) associated with the action “Play Favorite Playlist.”

The following numbered examples may illustrate one or more aspects of the disclosure:

### Example 1

A method comprising: outputting, by a computing device and for display at a display device, a first graphical user interface that includes a single graphical element corresponding to a grouping of a plurality of applications, wherein: a plurality of actions is associated with the plurality of applications, each action from the plurality of actions is associated with a respective application from the plurality of applications, and each action from the plurality of actions is an action to be performed by the respective application during execution of the respective application; determining, by the computing device, from the plurality of actions, a subset of actions that are more likely to be selected, by a user, than other actions from the plurality of actions that are not included in the subset; receiving, by the computing device, an indication of a user input that selects the single graphical element; determining, by the computing device, whether the user input is a first type of user input or a second type of user input; if the user input is a first type of user input, outputting, by the computing device and for display at the display device, a plurality of graphical elements, wherein each graphical element of the plurality of graphical elements corresponds to a respective application from the plurality of applications; and if the user input is a second type of user input, outputting, by the computing device and for display at the display device, a graphical indication of the subset of actions.

### Example 2

The method of example 1, wherein the user input is a first user input, wherein the graphical indication of the subset of actions includes a plurality of action graphical elements, each action graphical element corresponding to a respective action in the subset of actions, the method further comprising: receiving, by the computing device, an indication of a second user input that selects a particular action graphical element of the plurality of action graphical elements; and executing, by the computing device, the action corresponding to the selected action graphical element.

### Example 3

The method of any combination of examples 1-2, further comprising determining, by the computing device, a value of a characteristic of the user input, wherein determining the subset of actions includes determining, by the computing device, the subset of actions based on the value of the characteristic of the user input.

### Example 4

The method of example 3, wherein the subset of actions is a particular subset of actions, and wherein determining the particular subset of actions further comprises: determining, by the computing device, whether the value of the characteristic satisfies a threshold value for the characteristic; if the value of the characteristic satisfies a threshold value for the characteristic, determining, by the computing device, from a first subset of actions and a second subset of actions, the first subset of actions as the particular subset of actions; and if the value of the characteristic does not satisfy the threshold value for the characteristic, determining, by the computing device, from the first subset of actions and the second subset of actions, the second subset of actions as particular the subset of actions.

### Example 5

The method of any combination of examples 3-4, wherein the subset of actions is a first subset of actions, the method further comprising: responsive to determining that the value of the characteristic has changed: determining, by the computing device, a second subset of actions from the plurality of actions; and outputting, by the computing device and for display at the display device, a graphical indication of the second subset of actions.

### Example 6

The method of any combination of examples 1-5, wherein determining the subset of actions is based at least in part on an amount of use, by an active user of the computing device, of each action in the plurality of actions.

### Example 7

The method of any combination of examples 1-6, wherein determining the subset of actions is based at least in part on an amount of use, by an active user of the computing device, of each application in the plurality of applications.

### Example 8

The method of any combination of examples 1-7, wherein determining the subset of actions is based at least in part on an amount of use, by a group of users similar to an active user of the computing device, of each action in the plurality of actions.

### Example 9

The method of example 8, further comprising: determining, by the computing device, that a first application of the plurality of applications is similar to a second application of the plurality of applications; determining, by the computing device, that a first action of the first application is similar to a second action of the second application; determining, by the computing device and based on the user interactions by the group of similar users, the group of similar users utilize the first action more than the second action; and responsive to determining that the group of similar users utilize the first action more than second action, determining, by the computing device, that the subset of actions includes the first action.

### Example 10

The method of any combination of examples 1-9, wherein determining whether the user input is the first type of user input or the second type of user input comprises: determining, by the computing device, whether a value of a characteristic of the user input satisfies a threshold value; determining that the user input is the first type of user input responsive to determining, by the computing device, that the value of a characteristic of the user input does not satisfy the threshold value; and determining that the user input is the second type of user input responsive to determining, by the computing device, that the value of the characteristic of the user input satisfies the threshold value.

### Example 11

The method of example 10, wherein the characteristic of the user input comprises one of: a force of the user input, a pressure of the user input, or a duration of the user input.

### Example 12

A computing device comprising: at least one processor; and a memory comprising instructions that, when executed by the at least one processor, cause the at least one processor to: output, for display at a display device, a graphical user interface that includes a single graphical element corresponding to a grouping of a plurality of applications, wherein: a plurality of actions is associated with the plurality of applications, each action from the plurality of actions is associated with a respective application from the plurality of applications, and each action from the plurality of actions is an action to be performed by the respective application during execution of the respective application; determine, from the plurality of actions, a subset of actions that are more likely to be selected, by a user, than other actions from the plurality of actions that are not included in the subset; receive, an indication of a user input that selects the single graphical element; determine whether the user input is a first type of user input or a second type of user input; if the user input is a first type of user input, output, for display at the display device, a plurality of graphical elements, wherein each graphical element of the plurality of graphical elements corresponds to a respective application from the plurality of applications; and if the user input is a second type of user input, output, for display at the display device, a graphical indication of the subset of actions.

### Example 13

The computing device of example 12, wherein the user input is a first user input, wherein the graphical indication of the subset of actions includes a plurality of action graphical elements, each action graphical element corresponding to a respective action in the subset of actions, and wherein the instructions further cause the at least one processor to: receive an indication of a second user input that selects a particular action graphical element of the plurality of action graphical elements; and execute the action corresponding to the selected action graphical element.

### Example 14

The computing device of any combination of examples 12-13, wherein the instructions further cause the at least one processor to determine a value of a characteristic of the user input, and wherein the instructions cause the at least one processor to determine the subset of actions based on the value of the characteristic of the user input.

### Example 15

The computing device of example 14, wherein the subset of actions is a particular subset of actions, and wherein the instructions cause the least one processor to determine the particular subset of actions by at least causing the at least one processor to: determine whether the value of the characteristic satisfies a threshold value for the characteristic; if the value of the characteristic satisfies a threshold value for the characteristic, determine, from a first subset of actions and a second subset of actions, the first subset of actions as the particular subset of actions; and if the value of the characteristic does not satisfy the threshold value for the characteristic, determine, from the first subset of actions and the second subset of actions, the second subset of actions as particular the subset of actions.

### Example 16

The computing device of any combination of examples 14-15, wherein the subset of actions is a first subset of actions, and wherein the instructions further cause the at least one processor to: responsive to determining that the value of the characteristic has changed: determine a second subset of actions from the plurality of actions; and output, for display at the display device, a graphical indication of the second subset of actions.

### Example 17

The computing device of any combination of examples 12-16, wherein the instructions cause the at least one processor to determine the subset of actions based at least in part on an amount of use, by an active user of the computing device, of each action in the plurality of actions.

### Example 18

The computing device of any combination of examples 12-17, wherein the instructions cause the at least one processor to determine the subset of actions based at least in part on an amount of use, by a group of users similar to an active user of the computing device, of each action in the plurality of actions.

### Example 19

The computing device of any combination of examples 12-18, wherein the instructions cause the at least one processor to determine the subset of actions based at least in part on an external factor as the external factor affects an amount of use, by an active user of the computing device, of each action in the plurality of actions.

### Example 20

A computer-readable storage medium encoded with instructions that, when executed by at least one processor of a computing device, cause the at least one processor to: output, for display at a display device, a graphical user interface that includes a single graphical element corresponding to a grouping of a plurality of applications, wherein: a plurality of actions is associated with the plurality of applications, each action from the plurality of actions is associated with a respective application from the plurality of applications, and each action from the plurality of actions is an action to be performed by the respective application during execution of the respective application; determine, from the plurality of actions, a subset of actions that are more likely to be selected, by a user, than other actions from the plurality of actions that are not included in the subset; receive, an indication of a user input that selects the single graphical element; determine whether the user input is a first type of user input or a second type of user input; if the user input is a first type of user input, output, for display at the display device, a plurality of graphical elements, wherein each graphical element of the plurality of graphical elements corresponds to a respective application from the plurality of applications; and if the user input is a second type of user input, output, for display at the display device, a graphical indication of the subset of actions.

### Example 21

A system comprising: means for outputting, for display at a display device, a first graphical user interface that includes a single graphical element corresponding to a grouping of a plurality of applications, wherein: a plurality of actions is associated with the plurality of applications, each action from the plurality of actions is associated with a respective application from the plurality of applications, and each action from the plurality of actions is an action to be performed by the respective application during execution of the respective application; means for determining, from the plurality of actions, a subset of actions that are more likely to be selected, by a user, than other actions from the plurality of actions that are not included in the subset; means for receiving an indication of a user input that selects the single graphical element; means for determining whether the user input is a first type of user input or a second type of user input; if the user input is a first type of user input, means for outputting, for display at the display device, a plurality of graphical elements, wherein each graphical element of the plurality of graphical elements corresponds to a respective application from the plurality of applications; and if the user input is a second type of user input, means for outputting, for display at the display device, a graphical indication of the subset of actions.

### Example 22

The system of example 21, wherein the user input is a first user input, wherein the graphical indication of the subset of actions includes a plurality of action graphical elements, each action graphical element corresponding to a respective action in the subset of actions, the system further comprising: means for receiving an indication of a second user input that selects a particular action graphical element of the plurality of action graphical elements; and means for executing the action corresponding to the selected action graphical element.

### Example 23

The system of any combination of examples 21-22, further comprising means for determining a value of a characteristic of the user input, wherein means for determining the subset of actions includes means for determining the subset of actions based on the value of the characteristic of the user input.

### Example 24

The system of example 23, wherein the subset of actions is a particular subset of actions, and wherein the means for determining the particular subset of actions further comprises: means for determining whether the value of the characteristic satisfies a threshold value for the characteristic; if the value of the characteristic satisfies a threshold value for the characteristic, means for determining, from a first subset of actions and a second subset of actions, the first subset of actions as the particular subset of actions; and if the value of the characteristic does not satisfy the threshold value for the characteristic, means for determining, from the first subset of actions and the second subset of actions, the second subset of actions as particular the subset of actions.

### Example 25

The system of any combination of examples 23-24, wherein the subset of actions is a first subset of actions, the system further comprising: responsive to determining that the value of the characteristic has changed: means for determining a second subset of actions from the plurality of actions; and means for outputting, for display at the display device, a graphical indication of the second subset of actions.

### Example 26

The system of any combination of examples 21-25, wherein determining the subset of actions is based at least in part on an amount of use, by an active user of the computing device, of each action in the plurality of actions.

### Example 27

The system of any combination of examples 21-26, wherein determining the subset of actions is based at least in part on an amount of use, by an active user of the computing device, of each application in the plurality of applications.

### Example 28

The system of any combination of examples 21-27, wherein determining the subset of actions is based at least in part on an amount of use, by a group of users similar to an active user of the computing device, of each action in the plurality of actions.

### Example 29

The system of example 28, further comprising: means for determining that a first application of the plurality of applications is similar to a second application of the plurality of applications; means for determining that a first action of the first application is similar to a second action of the second application; means for determining, based on the user interactions by the group of similar users, the group of similar users utilize the first action more than the second action; and responsive to determining that the group of similar users utilize the first action more than second action, means for determining that the subset of actions includes the first action.

### Example 30

The system of any combination of examples 21-29, wherein the means for determining whether the user input is the first type of user input or the second type of user input comprises: means for determining whether a value of a characteristic of the user input satisfies a threshold value, means for determining that the user input is the first type of user input responsive to determining that the value of a characteristic of the user input does not satisfy the threshold value, and means for determining that the user input is the second type of user input responsive to determining that the value of the characteristic of the user input satisfies the threshold value.

### Example 31

The system of example 30, wherein the characteristic of the user input comprises one of: a force of the user input, a pressure of the user input, or a duration of the user input.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by a computing device and for display at a display device, a graphical user interface that includes a single graphical element corresponding to a grouping of a plurality of applications, wherein:
a plurality of actions is associated with the plurality of applications,
each action from the plurality of actions is associated with a respective application from the plurality of applications, and
each action from the plurality of actions is an action to be performed by the respective application during execution of the respective application;
determining, by the computing device, from the plurality of actions, a subset of actions that are more likely to be selected, by a user, than other actions from the plurality of actions that are not included in the subset;
receiving, by the computing device, an indication of a user input that selects the single graphical element;
determining, by the computing device, whether the user input is a first type of user input or a second type of user input;
if the user input is a first type of user input, outputting, by the computing device and for display at the display device, a plurality of graphical elements, wherein each graphical element of the plurality of graphical elements corresponds to a respective application from the plurality of applications; and
if the user input is a second type of user input, outputting, by the computing device and for display at the display device, a graphical indication of the subset of actions.

2. The method of claim 1, wherein the user input is a first user input, wherein the graphical indication of the subset of actions includes a plurality of action graphical elements, each action graphical element corresponding to a respective action in the subset of actions, the method further comprising:
receiving, by the computing device, an indication of a second user input that selects a particular action graphical element of the plurality of action graphical elements; and
executing, by the computing device, the action corresponding to the selected action graphical element.

3. The method of claim 1, further comprising determining, by the computing device, a value of a characteristic of the user input:
wherein determining the subset of actions includes determining, by the computing device, the subset of actions based on the value of the characteristic of the user input.

4. The method of claim 3, wherein the subset of actions is a particular subset of actions, and wherein determining the particular subset of actions further comprises:
determining, by the computing device, whether the value of the characteristic satisfies a threshold value for the characteristic;
if the value of the characteristic satisfies a threshold value for the characteristic, determining, by the computing device, from a first subset of actions and a second subset of actions, the first subset of actions as the particular subset of actions; and
if the value of the characteristic does not satisfy the threshold value for the characteristic, determining, by the computing device, from the first subset of actions and the second subset of actions, the second subset of actions as the particular subset of actions.

5. The method of claim 3, wherein the subset of actions is a first subset of actions, the method further comprising:
responsive to determining that the value of the characteristic has changed:
determining, by the computing device, a second subset of actions from the plurality of actions; and
outputting, by the computing device and for display at the display device, a graphical indication of the second subset of actions.

6. The method of claim 1, wherein determining the subset of actions is based at least in part on an amount of use, by an active user of the computing device, of each action in the plurality of actions.

7. The method of claim 1, wherein determining the subset of actions is based at least in part on an amount of use, by an active user of the computing device, of each application in the plurality of applications.

8. The method of claim 1, wherein determining the subset of actions is based at least in part on an amount of use, by a group of users similar to an active user of the computing device, of each action in the plurality of actions.

9. The method of claim 8, further comprising:
determining, by the computing device, that a first application of the plurality of applications is similar to a second application of the plurality of applications;
determining, by the computing device, that a first action of the first application is similar to a second action of the second application;
determining, by the computing device and based on the user interactions by the group of similar users, the group of similar users utilize the first action more than the second action; and
responsive to determining that the group of similar users utilize the first action more than second action, determining, by the computing device, that the subset of actions includes the first action.

10. The method of claim 1, wherein determining whether the user input is the first type of user input or the second type of user input comprises:
determining, by the computing device, whether a value of a characteristic of the user input satisfies a threshold value;
determining that the user input is the first type of user input responsive to determining, by the computing device, that the value of a characteristic of the user input does not satisfy the threshold value; and
determining that the user input is the second type of user input responsive to determining, by the computing device, that the value of the characteristic of the user input satisfies the threshold value.

11. The method of claim 10, wherein the characteristic of the user input comprises one of:
a force of the user input,
a pressure of the user input, or
a duration of the user input.

12. A computing device comprising:
at least one processor; and
a memory comprising instructions that, when executed by the at least one processor, cause the at least one processor to:
output, for display at a display device, a graphical user interface that includes a single graphical element corresponding to a grouping of a plurality of applications, wherein:
a plurality of actions is associated with the plurality of applications,
each action from the plurality of actions is associated with a respective application from the plurality of applications, and
each action from the plurality of actions is an action to be performed by the respective application during execution of the respective application;
determine, from the plurality of actions, a subset of actions that are more likely to be selected, by a user, than other actions from the plurality of actions that are not included in the subset;
receive, an indication of a user input that selects the single graphical element;
determine whether the user input is a first type of user input or a second type of user input;
if the user input is a first type of user input, output, for display at the display device, a plurality of graphical elements, wherein each graphical element of the plurality of graphical elements corresponds to a respective application from the plurality of applications; and
if the user input is a second type of user input, output, for display at the display device, a graphical indication of the subset of actions.

13. The computing device of claim 12, wherein the user input is a first user input, wherein the graphical indication of the subset of actions includes a plurality of action graphical elements, each action graphical element corresponding to a respective action in the subset of actions, and wherein the instructions further cause the at least one processor to:
receive an indication of a second user input that selects a particular action graphical element of the plurality of action graphical elements; and
execute the action corresponding to the selected action graphical element.

14. The computing device of claim 12, wherein the instructions further cause the at least one processor to determine a value of a characteristic of the user input, and
wherein the instructions cause the at least one processor to determine the subset of actions based on the value of the characteristic of the user input.

15. The computing device of claim 14, wherein the subset of actions is a particular subset of actions, and wherein the instructions cause the least one processor to determine the particular subset of actions by at least causing the at least one processor to:
determine whether the value of the characteristic satisfies a threshold value for the characteristic;
if the value of the characteristic satisfies a threshold value for the characteristic, determine, from a first subset of actions and a second subset of actions, the first subset of actions as the particular subset of actions; and
if the value of the characteristic does not satisfy the threshold value for the characteristic, determine, from the first subset of actions and the second subset of actions, the second subset of actions as particular the subset of actions.

16. The computing device of claim 14, wherein the subset of actions is a first subset of actions, and wherein the instructions further cause the at least one processor to:
responsive to determining that the value of the characteristic has changed:
determine a second subset of actions from the plurality of actions; and
output, for display at the display device, a graphical indication of the second subset of actions.

17. The computing device of claim 12, wherein the instructions cause the at least one processor to determine the subset of actions based at least in part on an amount of use, by an active user of the computing device, of each action in the plurality of actions.

18. The computing device of claim 12, wherein the instructions cause the at least one processor to determine the subset of actions based at least in part on an amount of use, by a group of users similar to an active user of the computing device, of each action in the plurality of actions.

19. The computing device of claim 12, wherein the instructions cause the at least one processor to determine the subset of actions based at least in part on an external factor as the external factor affects an amount of use, by an active user of the computing device, of each action in the plurality of actions.

20. A computer-readable storage medium encoded with instructions that, when executed by at least one processor of a computing device, cause the at least one processor to:
output, for display at a display device, a graphical user interface that includes a single graphical element corresponding to a grouping of a plurality of applications, wherein:
a plurality of actions is associated with the plurality of applications,
each action from the plurality of actions is associated with a respective application from the plurality of applications, and
each action from the plurality of actions is an action to be performed by the respective application during execution of the respective application;
determine, from the plurality of actions, a subset of actions that are more likely to be selected, by a user, than other actions from the plurality of actions that are not included in the subset;
receive, an indication of a user input that selects the single graphical element;
determine whether the user input is a first type of user input or a second type of user input;
if the user input is a first type of user input, output, for display at the display device, a plurality of graphical elements, wherein each graphical element of the plurality of graphical elements corresponds to a respective application from the plurality of applications; and
if the user input is a second type of user input, output, for display at the display device, a graphical indication of the subset of actions.
